(19) United States
(12) Patent Application Publication
(10) Pub. No.: US 2021/0081896 A1
(43) Pub. Date: Mar. 18, 2021

(54) SYSTEMS AND METHODS FOR DETERMINING OWNERSHIP AND ASSIGNING COVERAGE FOR EXCEPTIONS

(71) Applicant: JPMORGAN CHASE BANK, N.A., New York, NY (US)

(72) Inventors: Matthew WINN, Stirling (GB); Donna Faup BAILEY, Riverside, CT (US); Brian R. LUTZOW, Haddonfield, CT (US)

(21) Appl. No.: 17/022,864

(22) Filed: Sep. 16, 2020

Related U.S. Application Data
(60) Provisional application No. 62/900,706, filed on Sep. 16, 2019.

(51) Int. Cl. G06Q 10/10; G06Q 10/06; G06Q 40/04; G06Q 20/40; G06F 16/23; G06N 20/00; G06F 40/40

(52) U.S. Cl. CPC G06Q 10/103; G06Q 10/06311; G06Q 10/107; G06F 40/40; G06Q 20/405; G06F 16/2379; G06N 20/00; G06Q 40/04

(57) ABSTRACT

Systems and methods for determining ownership and assigning coverage for exceptions are disclosed. In one embodiment, in an information processing apparatus comprising at least one computer processor, a method for determining ownership and assigning coverage for exceptions may include: (1) receiving input data from an input platform; (2) identifying an exception from the input data; (3) enriching the exception with at least one of additional transaction details, market references, and normalized status/exception types; (4) automatically identifying a team to route the enriched exception based on a routing rule; (5) routing the exception to the identified team; (6) receiving acceptance or rejection of the exception from the identified team; and (7) updating the routing rule based on the acceptance or rejection.

### RELATED APPLICATIONS

This application claims priority to, and the benefit of, U.S. Provisional Patent Application Ser. No. 62/900,706 filed Sep. 16, 2019, the disclosure of which is hereby incorporated by reference, in its entirety.

### BACKGROUND OF THE INVENTION

### 1. Field of the Invention

The present disclosure generally relates to systems and methods for determining ownership and assigning coverage for exceptions.

### 2. Description of the Related Art

Financial institutions process transactions, breaks and related communications on a daily basis. In some cases, these transactions that result in exceptions have to be resolved through the trade lifecycle. Depending on exception type, specific teams are required to identify and resolve those exceptions which is time consuming and inefficient.

### SUMMARY OF THE INVENTION

Systems and methods for determining ownership and assigning coverage for exceptions are disclosed. In one embodiment, in an information processing apparatus comprising at least one computer processor, a method for determining ownership and assigning coverage for exceptions may include: (1) receiving input data from an input platform; (2) identifying an exception from the input data; (3) enriching the exception with at least one of additional transaction details, market references, and normalized status/exception types; (4) automatically identifying a team to route the enriched exception based on a routing rule; (5) routing the exception to the identified team; (6) receiving acceptance or rejection of the exception from the identified team; and (7) updating the routing rule based on the acceptance or rejection.

In one embodiment, the input data may include client allocation data, trade allocation data, settlement mission data, positions data, journals, vendor business exception data, agent position break data and agent nostro break data, emails and communications, market allegement data, etc.

In one embodiment, the exception may be identified using close matching.

In one embodiment, close matching may include identifying a market allegement and paring a transaction with the market allegement.

In one embodiment, the exception may be enriched using data science and/or natural language processing.

In one embodiment, the routing rule may include logic and/or tables.

In one embodiment, the exception may be routed based on a type of exception, a product, a workflow application for resolution, etc.

In one embodiment, the exception may be routed with a user interface view that may be specific to a type of the exception of the identified team.

In one embodiment, the method may further include re-routing the exception to a second team using the updated routing rule in response to the exception being rejected by the identified team.

In one embodiment, the method may further include automatically identifying a second team to route the enriched exception based on the routing rule in response to the exception being rejected; and presenting the recommended second team to the first team.

According to another embodiment, a system for determining ownership and assigning coverage for exceptions may include at least one input platform that provides input data; an exception enrichment platform that identifies an exception in the input data and enriches the exception with at least one of additional transaction details, market references, and normalized status/exception types; a coverage and ownership rules engine that automatically identifies a team to route the enriched exception based on a routing rule; a user interface that presents the exception to the identified team; and an algorithmic enrichment platform that receives acceptance or rejection of the exception from the identified team and updates the routing rule based on the acceptance or rejection.

In one embodiment, the input data may include client allocation data, trade allocation data, settlement mission data, positions data, journals, vendor business exception data, agent position break data and agent nostro break data, emails and communications, market allegement data, etc.

In one embodiment, the exception may be identified using close matching.

In one embodiment, close matching may include identifying a market allegement and paring a transaction with the market allegement.

In one embodiment, the exception may be enriched using data science and/or natural language processing.

In one embodiment, the routing rule may include logic and/or tables.

In one embodiment, the exception may be routed based on a type of exception, a product, and a workflow application for resolution.

In one embodiment, the exception may be routed to the user interface with a user interface view that may be specific to a type of the exception of the identified team.

In one embodiment, the coverage and ownership rules engine may automatically re-route the exception to a second team using the updated routing rule in response to the exception being rejected by the identified team.

In one embodiment, the coverage and ownership rules engine may automatically identify a second team to route the enriched exception based on the routing rule in response to the exception being rejected, and the user interface may present the recommended second team to the first team.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for determining ownership and assigning coverage for exceptions according to an embodiment; and

FIG. 2 depicts a method for determining ownership and assigning coverage for exceptions according to an embodiment.

### DETAILED DESCRIPTION OF PREFERRED EMBODIMENTS

Systems and methods for determining ownership and assigning coverage for exceptions in a financial transaction processing system are disclosed.

Even when data has been integrated, processing systems still lack transaction ownership on straight-through processing (STP) breaks, such as reconciliation breaks, settlement fails, mismatches on trade match and settlement match processes and other related post trade exceptions. Thus, embodiments are directed to systems and methods that assign action ownership to a trade based on an exception state in real-time.

There are generally two levels for assignment of an exception: coverage and categorization. Within the coverage level, dependent on the stage of the trade lifecycle, there are multiple high-level exception categories. These may include, for example, non-STP trade booking exceptions, email queries linked to transactions, market status exceptions, post settlement reconciliation breaks, etc. Each high-level exception category may require that each transaction be enriched with transaction coverage groups as the trade processes through the lifecycle (e.g., middle office, pre-matching, back office, etc.). Transaction ownership may be passed to a façade layer eliminating the need to recalculate ownership at each stage of processing.

The categorization level may be based on exception action ownership routing. Within each transaction exception category, there may be specific actions required of the owner dependent on the sub-categorization (e.g., pending allocation, unmatched, economic discrepancy, trade breaks, etc.). Depending on the exception, the exception may be linked to one of the coverage teams.

For example, a client transaction may be received and booked in the front office. That transaction may be subsequently allocated and instructed to the market via the settlement processing application. The settlement processing application interfaces with the market throughout the day and receives updated transaction statuses.

A transaction status is an indicator from the market to inform the organization if there is another counterparty looking to exchange securities with organization. If a trade is unmatched, then there is a disagreement with the counterparty regarding transaction details. If a transaction is matched, both the organization and the counterparty agree on transaction details. The organization's operations looks to resolve issues with unmatched trades to get them matched. Once matched, we can exchange securities with our counterparties.

During the lifecycle of a transactions, both the booking and allocation systems and settlement processing systems may publish transaction details and trade statuses to the data layer. The data layer leverages unique identifiers included in the transaction message to “stitch” or connect the multiple messages related to the same transaction into one chain.

After the data layer produces one chained transaction message with the most current trade status, it then processes to a coverage and ownership tool. The coverage and ownership tool looks to assign a transaction resolution owner based on logic within the tool. Each transaction status is assigned to a specific owner. A matched transaction for example is assigned to a settlements team in this scenario for resolution.

For example, the transaction resolution owners may be represented by the pre-matching team, the client service team, the trade service team, the settlements team, etc. Once a team is assigned an expectation that team may perform a specific set of actions to resolve the issue, as highlighted in the action box.

In one embodiment, the same coverage and ownership tool may be used for each of the two models. Each transaction, regardless of being a claim, securities trade or another type of product, may follow the same pipeline to the coverage and ownership tool for assignment. Dependent on the relative status and stage in the trade lifecycle, the action owners will change. The data layer application may publish this information, which is subsequently consumed by the ownership and assignment tool.

A trade and claims visualization tool may be an application that displays all issues in one centralized place. As a status changes, this tool may receive an assignment message from the coverage and ownership tool. The assignment message may be used to determine which team is expected to resolve the issue. Once assigned, the tool may display the issue on the appropriate teams view until they clear the problem.

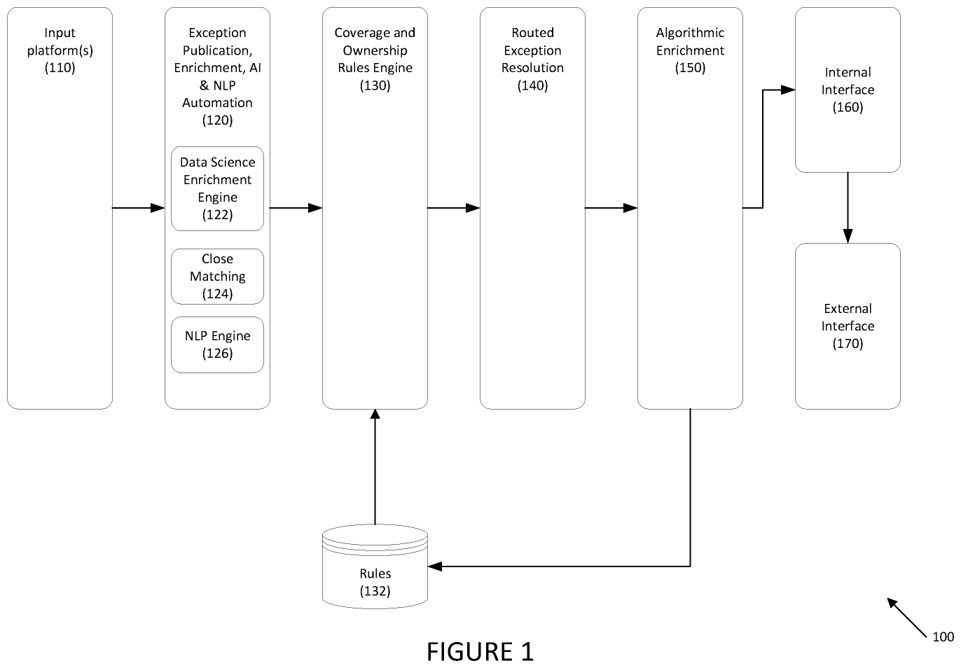

A high-level architecture of a system for determining ownership and assigning coverage for exceptions is provided in FIG. 1. System 100 may include input platform(s) 110, exception publication, enrichment, artificial intelligence and natural language processing automation 120, coverage and ownership rules engine 130, routed exception logic 140, algorithmic enrichment 145, internal interface 160, and external interface 170.

Input platform(s) 110 may include, for example, allocation platforms (e.g., platforms that provide client allocation data and business exception data), trade booking platforms (e.g., platforms that provide trade allocation data and business exception data), settlement platforms (e.g., platforms that provide settlement mission data and business exception data), books and records platforms (e.g., platforms that provide positions data, journals, and business exception data), vendor platforms and portals (e.g., platforms and portals that provide business exception data), reconciliation platforms (e.g., platforms that provide agent position break data and agent nostro break data), email and communications (e.g., client queries for trades, payments, etc.), market allegements (e.g., may provide market business exception data), etc. These inputs 110 are exemplary only, and additional or different inputs 110 may be provided as is necessary and/or desired.

Exception publication, enrichment, artificial intelligence and natural language processing (NLP) automation 120 may receive data from one or more input 110. In one embodiment, data may be provided to data science enrichment engine 122, to close matching engine 124, or to NLP engine 126.

For example, exception publication, enrichment, artificial intelligence and NLP automation 120 may enhance the exception with additional transaction details, market references, and normalized status/exception types. Examples include broker transactions, stock borrow loan transactions, client allocations, middle office ownership, pre-match ownership, market status, contract linkage, middle office exception, pre-match exception, notes/codes comments, email reference linkage, etc.

Coverage and ownership rules engine 130 may route the exception to an appropriate platform for exception resolution to align action ownership to the exception based on market status, exception type (e.g., client facing, broker facing, pre-match, back office, etc.). Examples of exception types include economic issues, short inventor, unmatched, trade breaks, etc.

In one embodiment, coverage and ownership rules engine 130 may apply an algorithm or rules, such as rules from rules database 132, to the exception. Coverage and ownership rules engine 130 may assign the exception to a team, individual, etc. and provides the exception to a workflow view on a user device.

For example, rules 132 may map groups of users to location, ownership or client accounts. In one embodiment, a user interface (UI) may be provided for users to change coverage rules 130, mapping relationships, etc. Coverage and ownership rules engine 130 may be callable by the systems of record so that coverage group can be stamped on an exception, fail, or break for publication to a bus and display on the relevant UIs.

Coverage and ownership rules engine 130 may also assign transaction coverage. Coverage may also be assigned “on the fly” using, for example, UI screens. For example, allocations, trades, and/or holdings where there is no exception are still “covered” by an operational group, but do not necessarily have this information “stamped” on, or associated with, the underlying transaction.

Routed exception logic 140 may provide one or more platform for resolving the exception. For example, routed exception logic 140 may include portals for external clients and vendors, machine learning exception automation tools, fails and exception dashboards, forecasting for forecasting fails, penalties, buy-ins, claims, etc. Routed exception logic may include interfaces with different teams (e.g., pre-matching team, client service team, trade support team, settlement team, etc.), and each team may be provided with a different visualization and may take different actions. For example, the pre-matching team may be provided with a visualization of unmatched transactions such as counterparty missing instructions, and may take an action, such as sending a message to the counterparty and request an update on the instruction status. The client service team may be provided with a visualization of economic issues and may process economic amendments in an allocation system via API, or by emailing the counterparty to amend to match the organization. The trade support team may also be provided with a visualization of economic issues and may process economic amendments in an allocation system via API, or by emailing the counterparty to amend to match the organization. The settlement team may be provided with a visualization of short fails and inventory, and may process inventory management if an inventory is not auto generated or correspondence is not received from the counterparty.

In one embodiment, the exception may be routed to a plurality of teams for resolution.

In one embodiment, machine learning may be used to route the workflow across applications and teams.

In one embodiment, machine learning may be used to route workflow(s) across applications. It may, for example, use identifications from manual reassignments within one application or between applications and enrich algorithm to properly route in future.

Algorithmic enrichment 150 may use machine learning to recognize manual coverage/ownership reassignments and enrich the rules in database 132.

Internal interface 160 may provide an interface for teams within the organization that are resolving the exception. In one embodiment, internal interface 160 may drive automation of exception notifications outbound and resolution actions inbound. In one embodiment, internal interface 160 may allow a user to reject an exception that has been improperly routed, to manually reassign an exception that has been improperly routed, or to accept an exception that has been properly routed. In on embodiment, the rejection, reassignment, and acceptance may be fed back to update rules 132.

External interface 170 may provide notifications (e.g., emails, messages, etc.) to external parties based on the resolution of the exception.

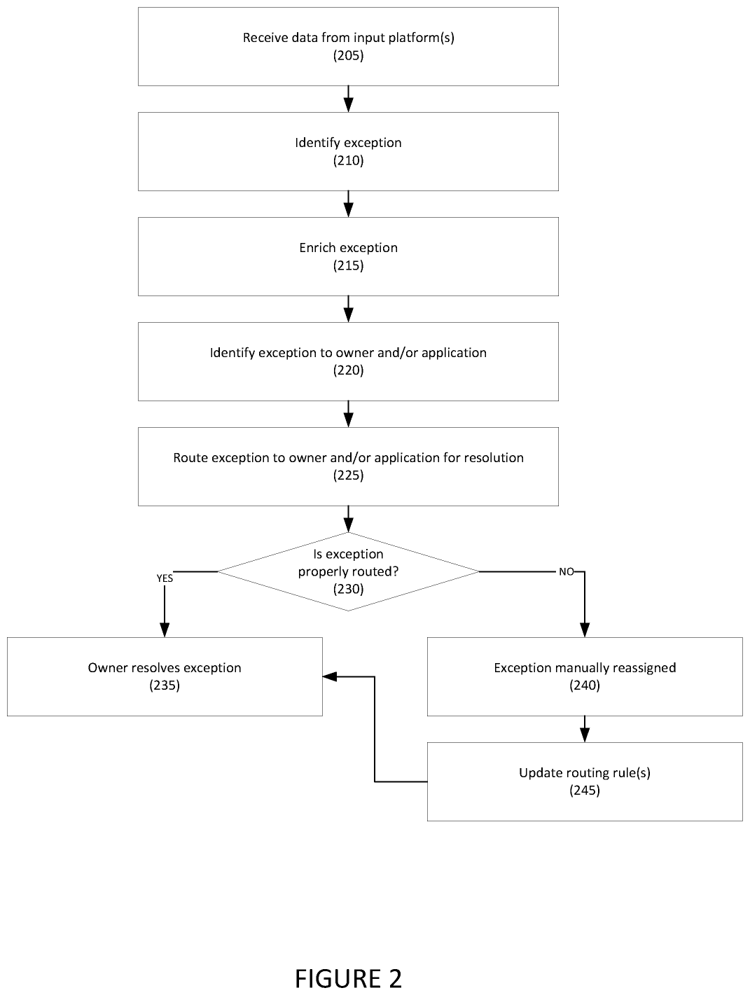

Referring to FIG. 2, a method for determining ownership and assigning coverage for exceptions is disclosed according to an embodiment.

In step 205, data may be received from one or more input platform. For example, data received from input platforms may include client allocation data, trade allocation data, settlement mission data, positions data, journals, vendor business exception data, agent position break data and agent nostro break data, emails and communications (e.g., client queries for trades, payments, etc.), market allegement data, etc. Other data may be received as is necessary and/or desired.

In step 210, one or more exception may be identified from the data. For example, exceptions may be identified by source applications, inbound client emails, market allegements, combinations thereof, etc.

In one embodiment, close matching may be used to identify exceptions. For example, tools may be used to identify market allegement(s) and systematically search for internal transactions that pair with the allegement(s). In one embodiment, users may review the exceptions and may perform resolution auctioning in event of discrepancies.

In step 215, the exception(s) may be enriched with additional transaction details, market references, and normalized status/exception types. Examples broker transactions, stock borrow loan transactions, client allocations, middle office ownership, pre-match ownership, market status, contract linkage, middle office exception, pre-match exception, notes/codes comments, email reference linkage, etc.

In embodiments, data science and/or natural language processing may be used to enrich the exception(s). For example, data science and NLP may be leveraged to perform actions such as data enrichment, exception coding, exceptions routing, exception resolutions, etc.

In step 220, a coverage and ownership engine may identity the proper team and/or application to route the exception to. For example, the coverage and ownership engine may leverage rules, such as logic and tables, to determine the coverage and route the exception to the correct team(s) and application(s) for resolution.

In one embodiment, the exception may be routed based on factors such as the type of exception, the product, the line of business a business exception can be routed to, one or multiple workflow applications for resolution by the appropriate business unit, etc. In some cases, workflow routing of an exception may be sent from one application to another application, and/or from one team to another team, in succession as issues are resolved.

In one embodiment, the coverage and ownership engine may apply rules from a rule database.

In one embodiment, the ownership may be identified in the exception, and no further analysis may be necessary.

In step 225, the exception may be routed to the identified team(s) and application(s).

In step 230, if the exception is incorrectly routed, in step 240, a user (e.g., an internal user) may reject the exception and may manually re-route the exception to the proper team or application. In step 245, the routing rules may be updated to reflect the re-routing.

In one embodiment, if the user rejects the exception, the user may be presented with a recommendation for a team and/or application for the user to assign the exception. In one embodiment, the recommendation may be based on machine learning using a process similar to that of step 220.

In another embodiment, once the user rejects the exception, the rules may be updated in step 245, and the exception may be returned to step 220 for reassignment. The exception may then be assigned, using the updated rules, to a new user or application.

In step 230, if the exception is properly routed, in step 235, the team and/or application may resolve the exception. In one embodiment, feedback may be provided to the routing rules database to confirm the proper routing. In one embodiment, the user may be presented with a recommended action for resolving the exception, such as presenting a recommendation based on past resolutions. The recommendation may be presented with a recommendation percentage, a color code (e.g., green, yellow, red) based on the anticipated correctness of the recommendation, etc.).

In one embodiment, the routing may provide user interface (UI) view for the user. In one embodiment, the UI screen data may provide line of business configurable view that provide both individuals and management with the information that they need to perform efficient exception resolution and a consolidate view of exception risk. UI screen data sources may include a cache, a data warehouse, a system of record API, etc. depending on the functional and non-functional requirements of the screen. For settlement fails, this may be a cache populated from the pub/sub bus. For transaction history, it may be a view of the warehouse.

In one embodiment, UI view may include views and filters to monitor outstanding risk and leverage workflow capabilities to track them through resolution. For example, each UI view may be specific to a team, and may provide a different view (e.g., unmatched—counterparty missing instruction view, economic issue view, short fails and inventory view, etc.) for each team. Each UI view may provide different resolution actions dependent on the team's role in resolving the resolution.

In one embodiment, the UI view may be configured based on user need and requirements. For each user and/or team, the UI view may include a queue of transactions that they are due to resolve and transactions other users are working on that line of business is interested in.

As an exemplary use case, the ownership of an equities client service exception action may be mapped throughout multiple stages of the trade lifecycle. In one embodiment, exception action resolvers may be presented with a consolidated work queue of actions under their ownership for remediation. Two sets of data may be provided to enable this view: (1) data availability and connectivity, which may connect to a façade layer and may present a consolidated view of all required middle office and back office data enabling efficient diagnosis of the error; and (2) API connectivity back to source, enabling resolution from visualization versus a requirement to go back to source system directly exception mapping and routing component. Depending on the stage in the lifecycle, group expected to resolve an issue will fluctuate between multiple departments.

Embodiments may provide some or all of the following: (1) each system of record may have a UI toolkit; (2) some UI screens may also aggregate events from multiple SORs (e.g., transaction history); (3) every UI view may have the same color scheme, fonts, etc.; (3) the UIs may use a service, such as IDAnywhere, for authentication, so that no additional login may be necessary as credentials are taken from the desktop level login; (5) a click through methodology is used where if a user right clicks on a settlement or a trade, the user will navigate to the position, while clicking on a box position takes the user to movements, etc. For lightweight integration, parameters on a URL may be passed between the UIs.

The disclosures of U.S. Patent Application Ser. No. 62/677,882 and 62/731,396 are hereby incorporated by reference in their entireties.

Although multiple embodiments have been disclosed, it should be recognized that these embodiments are not exclusive and features from one embodiment may be used with others.

Hereinafter general features of embodiments are provided.

The system of the invention or portions of the system of the invention may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ operating systems, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

1. A method for determining ownership and assigning coverage for exceptions, comprising:
in an information processing apparatus comprising at least one computer processor:
receiving input data from an input platform;
identifying an exception from the input data;
enriching the exception with at least one of additional transaction details, market references, and normalized status/exception types;
automatically identifying a team to route the enriched exception based on a routing rule;
routing the exception to the identified team;
receiving acceptance or rejection of the exception from the identified team; and
updating the routing rule based on the acceptance or rejection.

2. The method of claim 1, wherein the input data comprises at least one of client allocation data, trade allocation data, settlement mission data, positions data, journals, vendor business exception data, agent position break data and agent nostro break data, emails and communications and market allegement data.

3. The method of claim 1, wherein the exception is identified using close matching.

4. The method of claim 3, wherein close matching comprises identifying a market allegement and paring a transaction with the market allegement.

5. The method of claim 1, wherein the exception is enriched using at least one of data science and natural language processing.

6. The method of claim 1, wherein the routing rule comprises at least one of logic and tables.

7. The method of claim 1, wherein the exception is routed based on a type of exception, a product, and a workflow application for resolution.

8. The method of claim 1, wherein the exception is routed with a user interface view that is specific to a type of the exception of the identified team.

9. The method of claim 1, further comprising:
re-routing the exception to a second team using the updated routing rule in response to the exception being rejected by the identified team.

10. The method of claim 1, further comprising:
automatically identifying a second team to route the enriched exception based on the routing rule in response to the exception being rejected; and
presenting the recommended second team to the first team.

11. A system for determining ownership and assigning coverage for exceptions, comprising:
at least one input platform that provides input data;
an exception enrichment platform that identifies an exception in the input data and enriches the exception with at least one of additional transaction details, market references, and normalized status/exception types;
a coverage and ownership rules engine that automatically identifies a team to route the enriched exception based on a routing rule;
a user interface that presents the exception to the identified team; and
an algorithmic enrichment platform that receives acceptance or rejection of the exception from the identified team and updates the routing rule based on the acceptance or rejection.

12. The system of claim 11, wherein the input data comprises at least one of client allocation data, trade allocation data, settlement mission data, positions data, journals, vendor business exception data, agent position break data and agent nostro break data, emails and communications and market allegement data.

13. The system of claim 11, wherein the exception is identified using close matching.

14. The system of claim 13, wherein close matching comprises identifying a market allegement and paring a transaction with the market allegement.

15. The system of claim 11, wherein the exception is enriched using at least one of data science and natural language processing.

16. The system of claim 11, wherein the routing rule comprises at least one of logic and tables.

17. The system of claim 11, wherein the exception is routed based on a type of exception, a product, and a workflow application for resolution.

18. The system of claim 11, wherein the exception is routed to the user interface with a user interface view that is specific to a type of the exception of the identified team.

19. The system of claim 11, wherein the coverage and ownership rules engine automatically re-routes the exception to a second team using the updated routing rule in response to the exception being rejected by the identified team.

20. The method of claim 1, wherein the coverage and ownership rules engine automatically identifies a second team to route the enriched exception based on the routing rule in response to the exception being rejected, and the user interface presents the recommended second team to the first team.
